(19) United States
(12) Patent Application Publication
(10) Pub. No.: US 2017/0236619 A1
(43) Pub. Date: Aug. 17, 2017

(54) Cable For Use In A Remote Control Assembly

(71) Applicant: Kongsberg Driveline Systems I, Inc., Novi, MI (US)

(72) Inventor: Michael Jusick, Michigan Center, MI (US)

(21) Appl. No.: 15/044,513

(22) Filed: Feb. 16, 2016

(51) Int. Cl. H01B 7/04; H01B 7/02; H01B 3/30; H01B 3/47; H01B 7/295; H01B 3/00

(52) U.S. Cl. CPC H01B 7/04; H01B 7/295; H01B 3/002; H01B 3/301; H01B 3/303; H01B 3/47; H01B 7/0225; H01B 7/0258

(57) ABSTRACT

A cable for use in a remote control assembly includes a liner having a longitudinal axis along a length thereof and defining an interior. The cable includes a core element disposed and moveable within the interior and extending along the length. The cable additionally includes a sheath disposed about the liner along the length. The cable further includes a support layer mounted to and disposed between the liner and the sheath, with the support layer supporting the liner along the length, reinforcing the sheath along the length, reducing movement of the sheath with respect to the liner and vibrations caused during movement of the core element, and minimizing bending of the liner and the sheath about the longitudinal axis. The support layer is comprised of a resin material.

### BACKGROUND OF THE INVENTION

1. Field of the Invention

The invention generally relates to a cable for use in a remote control assembly.

2. Description of the Related Art

Various remote control assemblies have been developed for many applications. Typical use of remote control assemblies includes, but is not limited to, automotive applications such as control of automatic transmissions, accelerators, clutches, cruise controls, HVAC vents, and the like. Many of these applications include the transmission of motion in a curved path by a flexible transmitting core element slidably disposed in a conduit. These conduits typically include a liner having a longitudinal axis along a length thereof and defining an interior and a sheath disposed about the liner. The conduit and the core element collectively define a cable.

Typically, reinforcement of the sheath about the liner, along with additional support for the liner during movement of the core element is needed. Current designs of cables utilize at least one support wire for supporting the liner, for reinforcing the sheath along the length, for reducing movement of the sheath with respect to the liner during movement of the core element, and for minimizing bending of the liner and the sheath. Current designs of cables utilizing the support wires are often expensive to manufacture, are heavier than desired, and do not adequately support the liner, reinforce the sheath along the length, reduce movement of the sheath with respect to the liner during movement of the core element, and/or minimize bending of the liner and the sheath during operation of the remote control assembly.

As such, there remains an opportunity to design a cable for a remote control assembly that reduces the manufacturing costs. Also, there remains an opportunity to reduce the weight of the cable. Furthermore, there remains an opportunity to design a cable that provides further support for the liner, further reinforces the sheath along the length, further reduces movement of the sheath with respect to the liner during movement of the core element, and further minimizes bending of the liner and the sheath.

### SUMMARY OF THE INVENTION AND ADVANTAGES

A cable for use in a remote control assembly includes a liner having a longitudinal axis along a length thereof and defining an interior. The cable includes a core element disposed and moveable within the interior and extending along the length. The cable additionally includes a sheath disposed about the liner along the length. The cable further includes a support layer mounted to and disposed between the liner and the sheath, with the support layer supporting the liner along the length, reinforcing the sheath along the length, reducing movement of the sheath with respect to the liner and vibrations caused during movement of the core element, and minimizing bending of the liner and the sheath about the longitudinal axis. The support layer is comprised of a resin material.

Accordingly, the cable including the support layer comprised of a resin material reduces manufacturing costs and reduces the weight of the cable. Additionally, the cable provides further support for the liner, further reinforces the sheath along the length, further reduces movement of the sheath with respect to the liner during movement of the core element, and further minimizes bending of the liner and the sheath.

### BRIEF DESCRIPTION OF THE DRAWINGS

Other advantages of the present invention will be readily appreciated, as the same becomes better understood by reference to the following detailed description when considered in connection with the accompanying drawings.

FIG. 1 is a fragmented side view of a remote control assembly including a cable and end fittings.

FIG. 2 is an enlarged fragmented side view of a sheath and a support layer of the cable of FIG. 1 with the sheath shown in cross-section.

FIG. 3 is a fragmented side view of a portion of the cable of FIG. 1, with the sheath partially removed and shown in cross-section.

FIG. 4 is a front cross-sectional view of the cable of FIG. 1, with the cable including a liner having an inner layer, an intermediate layer, and an outer layer, and with the liner having a longitudinal axis.

FIG. 5 is a fragmented perspective view of the cable of FIG. 1 and the liner of FIG. 4, with a portion of the sheath and the support layer removed.

FIG. 6 is a fragmented perspective view of the cable of FIG. 1 and the liner of FIG. 4, with a portion of the sheath, the support layer, and the outer layer of the liner removed.

FIG. 7 is a fragmented perspective view of the cable of FIG. 1 and the liner of FIG. 4, with a portion of the sheath, the support layer, the outer layer, the intermediate layer, and the inner layer removed.

FIG. 8 is a fragmented perspective view of the cable of FIG. 1 and another embodiment of the liner, with the liner including an outer layer and an inner layer, and with a portion of the sheath and the support layer removed.

FIG. 9 is a fragmented perspective view of the cable of FIG. 1 and another embodiment of the liner, with the liner having a single layer, and with a portion of the sheath and the support layer removed.

FIG. 10 is a perspective view of the support layer of FIG. 2, with an outer support surface of the support layer defining a groove.

FIG. 11 is a perspective view of another embodiment of the support layer, with the outer support surface of the support layer defining an outer groove, with an inner support surface of the support layer defining an inner groove, and with the outer and inner grooves aligned with one another along the longitudinal axis.

FIG. 12 is a side cross-sectional view of the support layer of FIG. 11.

FIG. 13 is a perspective view of another embodiment of the support layer, with the outer groove and the inner groove offset from one another along the longitudinal axis.

FIG. 14 is a side cross-sectional view of the support layer of FIG. 13.

FIG. 15 is an enlarged side view of the support layer of FIG. 2.

FIG. 16 is a portion of the support layer of FIG. 15.

FIG. 17 is a perspective view of the sheath and the support layer of FIG. 2, with the sheath disposed within the one groove.

FIG. 18 is a portion of the sheath and the support layer of FIG. 17.

FIG. 19 is perspective view of the cable of FIG. 1, the liner of FIG. 4, and another embodiment of the support layer, with the support layer defining a plurality of grooves.

FIG. 20 is a perspective view of the support layer of FIG. 19.

FIG. 21 is a perspective view of another embodiment of the support layer, with an outer layer of the support layer defining the a plurality of outer grooves, with an inner surface of the support layer defining a plurality of inner grooves, and with the plurality of outer grooves and the plurality of inner grooves aligned with one another along the longitudinal axis.

FIG. 22 is a side cross-sectional view of the support layer of FIG. 21.

FIG. 23 is a perspective view of another embodiment of the support layer of FIG. 21, with the plurality of outer grooves and the plurality of inner grooves offset from one another along the longitudinal axis.

FIG. 24 is a side cross-sectional view of the support layer of FIG. 23.

FIG. 25 is a perspective view of the cable of FIG. 1, the liner of FIG. 4, and another embodiment of the support layer.

FIG. 26 is a perspective view of the cable of FIG. 1, the liner of FIG. 8, and the support layer of FIG. 25.

FIG. 27 is a perspective view of the cable of FIG. 1, the liner of FIG. 9, and the support layer of FIG. 25.

### DETAILED DESCRIPTION OF THE INVENTION

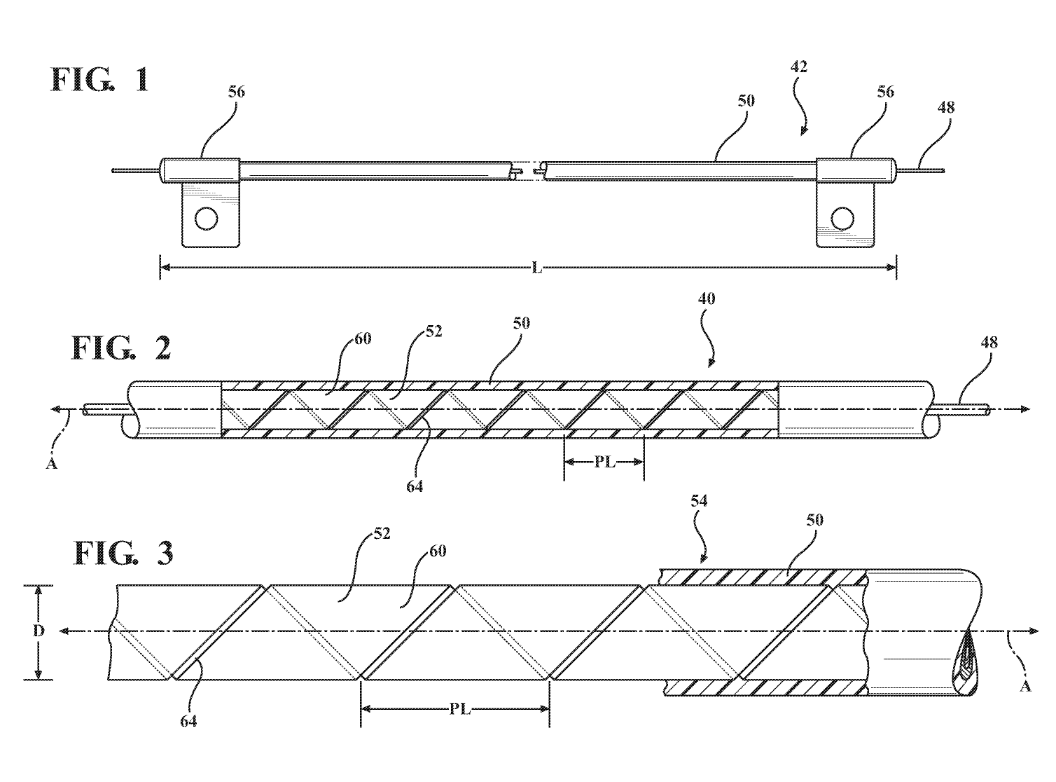

With reference to the Figures, wherein like numerals indicate like parts throughout the several views, a cable 40 is shown in FIGS. 1 and 2. The cable 40 is typically used in a remote control assembly 42, as shown in FIG. 1. Typical use of the cable 40 in a remote control assembly 42 includes, but is not limited to, automotive applications such as control of automatic transmissions, accelerators, clutches, cruise controls, HVAC vents, and the like. Although the cable 40 is shown as being used in the remote control assembly 42, it is to be appreciated that the cable 40 may be used in other applications without departing from the nature of the present invention.

The cable 40, as best shown in FIG. 5, includes a liner 44 having a longitudinal axis A along a length L. The liner 44 defines an interior 46 along length L. The liner 44 may be comprised of an organic polymer material, such as, but not limited to, polytetrafluoroethylene or high-density polyethylene. It is to be appreciated that other materials and configurations of the liner 44 may be utilized without departing from the nature of the present invention.

The cable 40 additionally includes a core element 48 disposed and moveable within the interior 46 of the liner 44 with the core element 48 extending along the length L. The liner 44 ensures flexibility and low friction support to permit the core element 48 to slideably move within the interior 46 of the liner 44. The core element 48 may take various forms, but is shown in the Figures as a metal wire element that is attachable to control members for transmitting motion therebetween along longitudinal axis A.

The cable 40 further includes a sheath 50 disposed about the liner 44 along length L. In certain embodiments, the sheath 50 comprises one or more organic polymers. Although the sheath 50 may comprise one or more organic polymers, in one embodiment the sheath 50 comprises nylon. When the sheath 50 comprises nylon, various forms of nylon can be used. For example, the nylon may be a polyamide nylon, nylon 6-6, or combinations thereof. In certain embodiments, the sheath 50 comprises nylon and one or more organic polymers. In other embodiments, the sheath 50 consists of nylon (i.e., no other organic polymers are present in the sheath 50). When the sheath 50 consists of nylon, the sheath 50 may consist of polyamide nylon. Of course, when the sheath 50 consists of polyamide nylon, the sheath 50 may consist of nylon 6-6. It is to be appreciated that the sheath 50 may be comprised of other suitable materials without departing from the nature of the present invention. It is to also be appreciated that the sheath 50 may be coated with a polyethylene or polypropylene layer without departing from the nature of the present invention.

The cable 40 also includes a support layer 52 mounted to and disposed between the liner 44 and the sheath 50. The support layer 52, the sheath 50, and the liner 44 collectively form a conduit 54.

The support layer 52 supports the liner 44 along length L. The support layer 52 additionally reinforces the sheath 50 along length L. The support layer 52 helps reduce movement of the sheath 50 with respect to the liner 44 and helps reduce vibrations caused during movement of the core element 48 within the interior 46 of the liner 44. The support layer 52 minimizes bending of the liner 44 and the sheath 50 about longitudinal axis A to help prevent kinks from occurring in the liner 44 and/or the sheath 50. Further, the support layer 52 dampens transmission of noise and other vibrations, i.e., noise, vibration, and harshness (NVH), induced from various sources, such as an engine. In one embodiment, the sheath 50 is the outermost layer of the cable 40, with the sheath 50 encapsulating the support layer 52 and the liner 44 such that the sheath 50 is exposed to the atmosphere. However, as described above, the sheath 50 may be coated with a polyethylene or polypropylene layer without departing from the nature of the present invention.

The support layer 52 is comprised of a resin material. The resin material of the support layer 52 provides the necessary support for the liner 44 and reinforcement for the sheath 50 required during use of the cable 40. Additionally, the resin material of the support layer 52 provides further support for the liner 44, further reinforces the sheath 50 along length L, further reduces movement of the sheath 50 with respect to the liner 44 during movement of the core element 48, and further minimizes bending of the liner 44 and the sheath 50. Additionally, the resin material of the support layer 52 is lightweight, which is advantageous when used in many applications, such as automotive applications.

The resin material of the support layer 52 may be a thermoplastic resin. Thermoplastic resins are advantageous in molding processes such as injection molding, which decreases manufacturing time when using the support layer 52 in the cable 40. Depending on the requirements of the support layer 52, i.e., hardness, tensile and compression strength, impact resistance, temperature resistance, and many other physical and mechanical properties, different thermoplastic resins may be selected as the resin material of the support layer 52.

In one embodiment, the resin material of the support layer 52 is a neat polyphenylene sulfide (PPS). In this embodiment, the PPS is typically free of any stabilizers or additives, i.e., is unfilled. PPS resins help the support layer 52 maintain thermal stability, dimensional stability, chemical resistance, and flame retardancy. Also, PPS is lightweight, which is advantageous when used in many applications, such as automotive applications. Although the PPS may be free of any stabilizers or additives, it is to be appreciated that the neat PPS may include additives or other stabilizers without departing from the nature of the present invention. Additives and stabilizers in the PPS can help improve impact resistance, hardness, strength, temperature resistance, and many other physical and mechanical properties. For example, the neat PPS may be 15 percent glass filled to help further reinforce the support layer 52. It is to be appreciated that the neat PPS may be more than or less than 15 percent glass filled without departing from the nature of the present invention. It is also to be appreciated that when the resin material of the support layer 52 is PPS that other additives and/or stabilizers may be added without departing from the nature of the present invention.

In another embodiment, the resin material of the support layer 52 is a polyphenylsulfone (PPSU). When the resin material of the support layer 52 is PPSU, the PPSU helps the support layer 52 be heat and chemical-resistant. Along with heat and chemical resistance, PPSU has a very high melting point and offers tensile and compression strength suitable for many automotive applications. PPSU is also lightweight, which is advantageous when used in many applications, such as automotive applications. In yet another embodiment, resin material of the support layer 52 is a polyphthalamide (PPA). When the resin material of the support layer 52 is PPA, the PPA gives the support layer 52 high mechanical strength and thermal resistance. Additionally, PPA is lightweight, which is advantageous in many applications, such as automotive applications. The PPA may be a high temperature nylon PPA. It is to be appreciated that other suitable materials may be used for the support layer 52 without departing from the nature of the present invention.

The conduit 54 may be free of support wires comprised of metal. In this embodiment, the support layer 52 provides support for the liner 44 along the length L, reinforces the sheath 50 along the length L, reduces movement of the sheath 50 with respect to the liner 44 and vibrations caused during movement of the core element 48, minimizes bending of the liner 44 and the sheath 50 about longitudinal axis A, and/or reduces dampens transmission of noise and other vibrations (NVH) induced from various sources, all of which are typically solved by using support wires comprised of metal. As described above, the resin material of the support layer 52 provides further support for the liner 44, further reinforces the sheath 50 along length L, further reduces movement of the sheath 50 with respect to the liner 44 during movement of the core element 48, and further minimizes bending of the liner 44 and the sheath 50. In this embodiment, the support layer 52 replaces the support wires comprised of metal, which helps reduce weight of the cable X, and helps decrease manufacturing time and overall cost of producing the cable 40. Moreover, the support layer 52 used in the cable 40 free of support wires comprised of metal has comparable compression strength to the support wires comprised of metal, which provides the cable 40 with adequate compression strength without the use of support wires comprised of metal, all while reducing weight and stiffness of the cable 40.

When the cable 40 is used in the remote control assembly 42, as best shown in FIG. 1, the remote control assembly 42 typically includes fittings 56. The fittings 56 support the cable 40, and in particular the conduit 54, therebetween. The fittings 56 may be fitted to the conduit 54 in any suitable manner, such as, but not limited to, overmolding to mechanically interlock the fittings 56 to the sheath 50 of the conduit 54 or using traditional fasteners without departing from the nature of the present invention. When the fittings 56 are overmolded onto the sheath 50 of the conduit 54, the fittings 56 may comprise polymeric or plastic materials, for example, nylon, Teflon, synthetic elastomers, polyvinyls, polyethylene (PE), polypropylene (PP), or their copolymers. It is to be appreciated that when the fittings 56 are fastened to the sheath 50 of the conduit 54 using traditional fasteners or any other suitable ways, the fittings 56 may comprise of a material other than the polymeric or plastic materials listed above. It is to be appreciated that the fittings 56 shown in FIG. 1 are schematic and other variations of the fittings 56 may be used without departing from the nature of the present invention.

In one embodiment, the liner 44 presents an outer liner surface 58 facing the support layer 52, and the support layer 52 presents both an outer support surface 60 engaged with the sheath 50 along length L and an inner support surface 62 engaged with the outer liner surface 58 along length L. In this embodiment, the support layer 52 encapsulates the liner 44. Said differently, as shown throughout the Figures, the support layer 52 is disposed about the liner 44 along length L such that the support layer 52 is continuously disposed between the liner 44 and the sheath 50. In other words, the support layer 52 is a continuous ring extending along length L and about longitudinal axis A such that the support layer 52 completely surrounds the liner 44. In this embodiment, the inner support surface 62 of the support layer 52 may be entirely engaged with the outer liner surface 58 along length L. In other words, there is no portion of the outer liner surface 58 that is not engaged with the inner support surface 62. When this is the case, the liner 44 is completely supported along length L, and the sheath 50 is reinforced along length L.

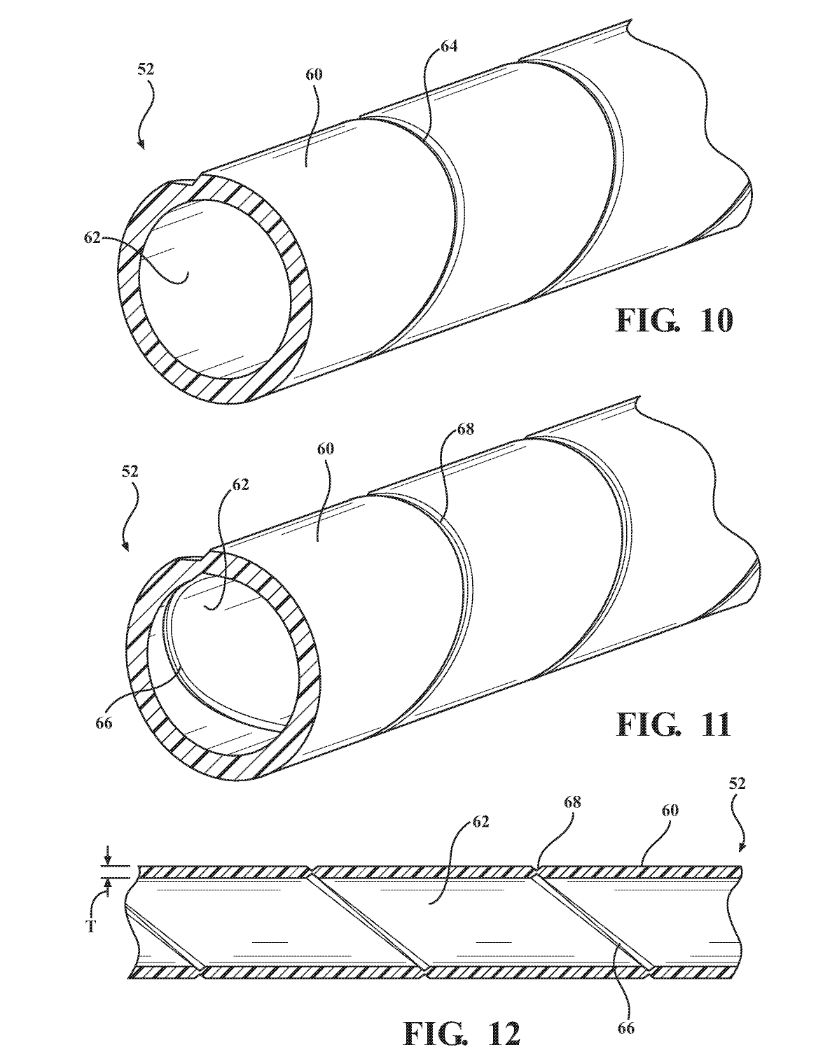

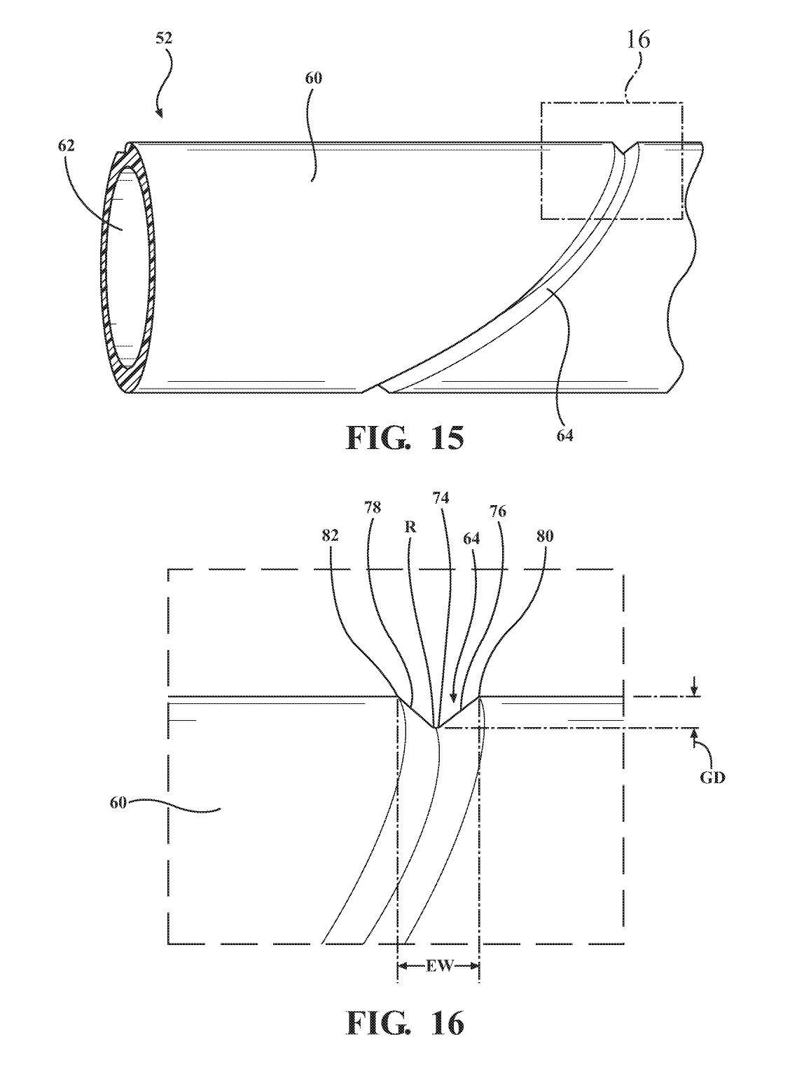

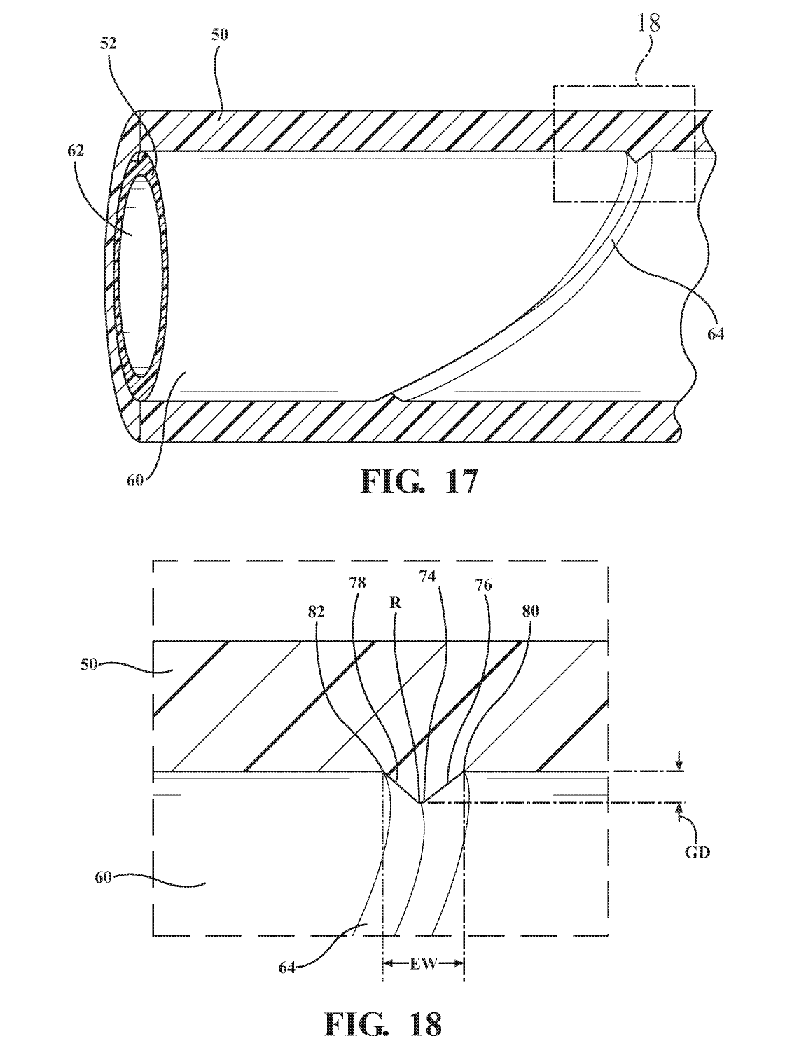

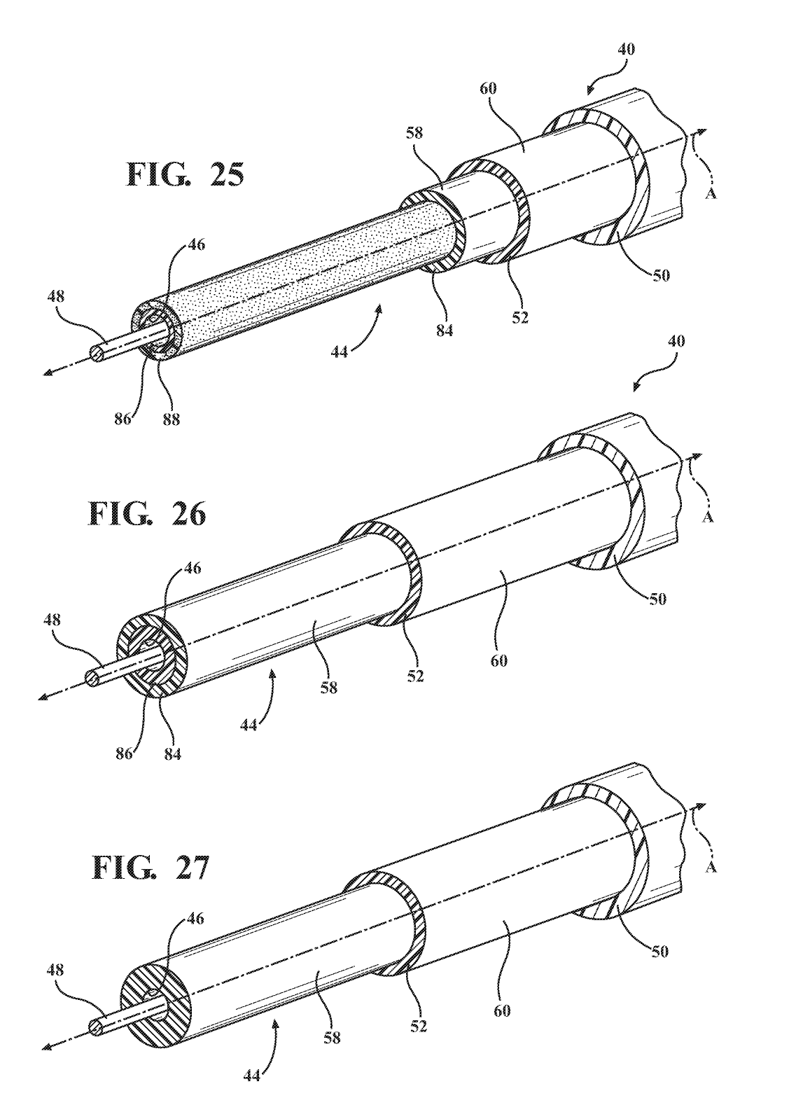

As shown in FIGS. 2-24, the outer support surface 60 of the support layer 52 may define at least one groove 64 for increasing flexibility of the support layer 52. The groove 64 allows the support layer 52 to flex during movement of the core element 48. Although the groove 64 helps with flexibility of the support layer 52, it is to be appreciated that the support layer 52 may be free of groove(s) 64, as shown in FIGS. 25-27, without departing from the nature of the present invention. In this embodiment, the outer support surface 60 and the inner support surface 62 are substantially smooth about longitudinal axis A along length L, i.e., free of grooves or ridges.

In one embodiment, a portion of the sheath 50 is disposed within the groove 64, as best shown in FIG. 18. When a portion of the sheath 50 is disposed within the groove 64, the sheath 50 is secured to the support layer 52 such that the support layer 52 does not move along longitudinal axis A during movement of the core element 48. Said differently, when a portion of the sheath 50 is disposed within the groove 64, the support layer 52 is secured to the sheath 50. Securing the support layer 52 to the sheath 50 such that the support layer 52 and the sheath 50 do not move with respect to one another helps reduce vibrations and noise caused during movement of the core element 48.

As shown in FIGS. 2-18, the groove 64 may be helically disposed about longitudinal axis A and along length L. As described above, the groove 64 increases the flexibility of the support layer 52. When the groove 64 is helically disposed about longitudinal axis A along length L, the groove 64 may be continuously disposed about longitudinal axis A along length L. When the groove 64 is continuously disposed about longitudinal axis A and along length L, the groove 64 may be a single groove. In other words, the groove 64 is defined by the support layer 52 about longitudinal axis A and along length L without any interruptions. However, it is to be appreciated that the support layer 52 may define more than one groove 64 about longitudinal axis A and along length L without departing from the nature of the present invention. For example, the outer support surface 60 may define multiple grooves 64 helically disposed about longitudinal axis A and along length L. It is also to be appreciated that the groove 64 may be defined by the outer support surface 60 and/or the inner support surface 62.

For example, as shown in FIGS. 11 and 12, the inner support surface 62 defines at least one inner groove 66 and the outer support surface 60 defines at least one outer groove 68. Both the inner groove 66 and the outer groove 68 may be helically disposed about longitudinal axis A along length L. When the inner groove 66 and the outer groove 68 are helically disposed about longitudinal axis A along length L, the inner groove 66 and the outer groove 68 may be continuously disposed about longitudinal axis A and along length L. When the inner groove 66 and the outer groove 68 are continuously disposed about longitudinal axis A and along length L, the inner groove 66 and/or the outer groove 68 may be a single groove. In other words, the inner groove 66 is defined by the inner support layer 52 about longitudinal axis A and along length L without any interruptions, and/or the outer groove 68 is defined by the outer support layer 52 about longitudinal axis A and along length L without any interruptions. However, it is to be appreciated that the inner support surface 62 and/or the outer support surface 60 may define more than one inner groove 66 and outer groove 68, respectively, about longitudinal axis A and along length L without departing from the nature of the present invention. It is to be further appreciated that the inner support surface 62 may define at least one inner groove 66 and the outer support surface 60 may be free of the outer groove 68 without departing from the nature of the present invention.

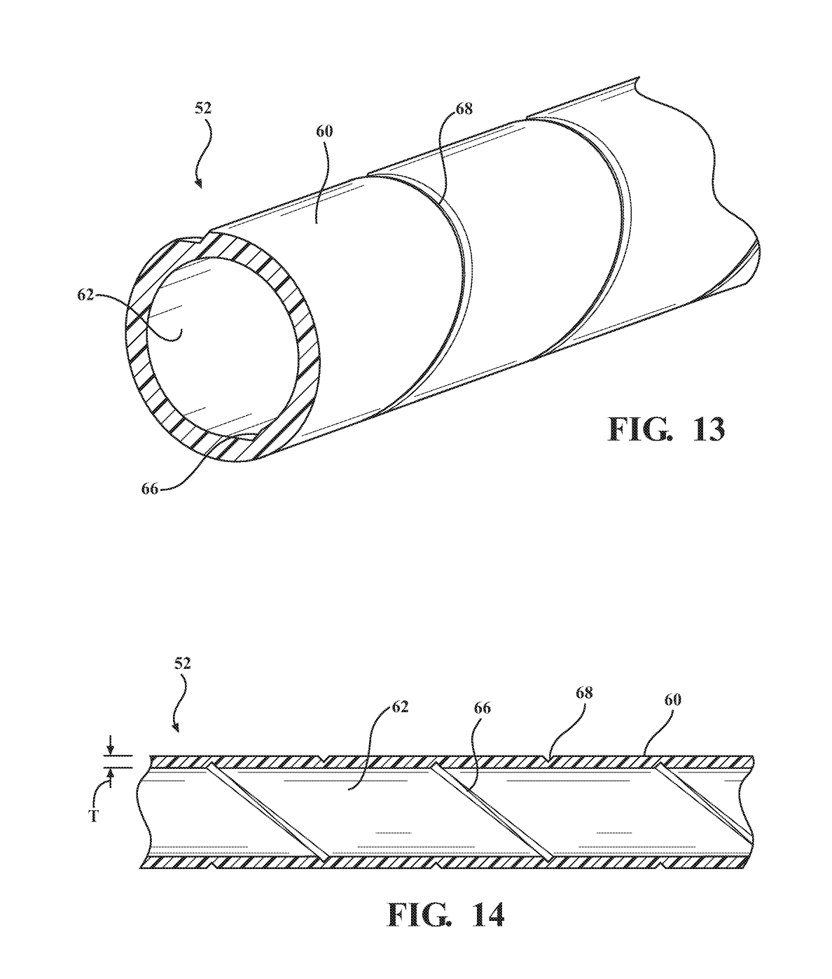

As shown in FIGS. 11 and 12, the inner groove 66 and the outer groove 68 are both helically disposed about longitudinal axis A and along length L. In this embodiment, the inner groove 66 and the outer groove 68 may be aligned with one another with respect to longitudinal axis A and along length L such that the inner groove 66 and the outer groove 68 are defined toward each other, as best shown in FIG. 12. However, the inner groove 66 and the outer groove 68 may be offset from one another with respect to longitudinal axis A and along length L, as shown in FIGS. 13 and 14. Depending on the desired flexibility of the support layer 52, the inner groove 66 and outer groove 68 may be aligned or offset from one another with respect to longitudinal axis A and along length L.

When the groove 64 is helically disposed about longitudinal axis A, as shown in FIGS. 2-18, the groove 64 is disposed about longitudinal axis A at a predetermined pitch length PL as measured relative to longitudinal axis A. Specifically, the support layer 52 defines a diameter D, and the pitch length PL is measured with respect to diameter D. In one embodiment, the pitch length PL is from about 6 to 7.25 times the diameter D. In another embodiment, the pitch length PL is about 6.6 times the diameter D. It is to be appreciated that the predetermined pitch length PL may be less than 6 times diameter D or greater than 7.25 times diameter D without departing from the nature of the present invention. For example, if greater flexibility of the support layer 52 were desired, the predetermined pitch length PL would be reduced to, for example, less than 6 times diameter D. If greater stiffness is desired in the support layer 52, the predetermined pitch length PL would be increased to, for example, greater than 7.25 the diameter D. Additionally, the support layer 52 may define a thickness T from the outer support surface 60 to the inner support surface 62. Depending on the thickness T of the support layer 52, the predetermined pitch length PL may be adjusted to achieve the desired flexibility given the thickness T and diameter D of the support layer 52. It is to be appreciated that the predetermined pitch length PL shown in FIGS. 2-18 is merely illustrative and may not be drawn to scale. As such, the predetermine pitch length PL may be greater or less than is shown throughout FIGS. 2-18 without departing from the nature of the present invention.

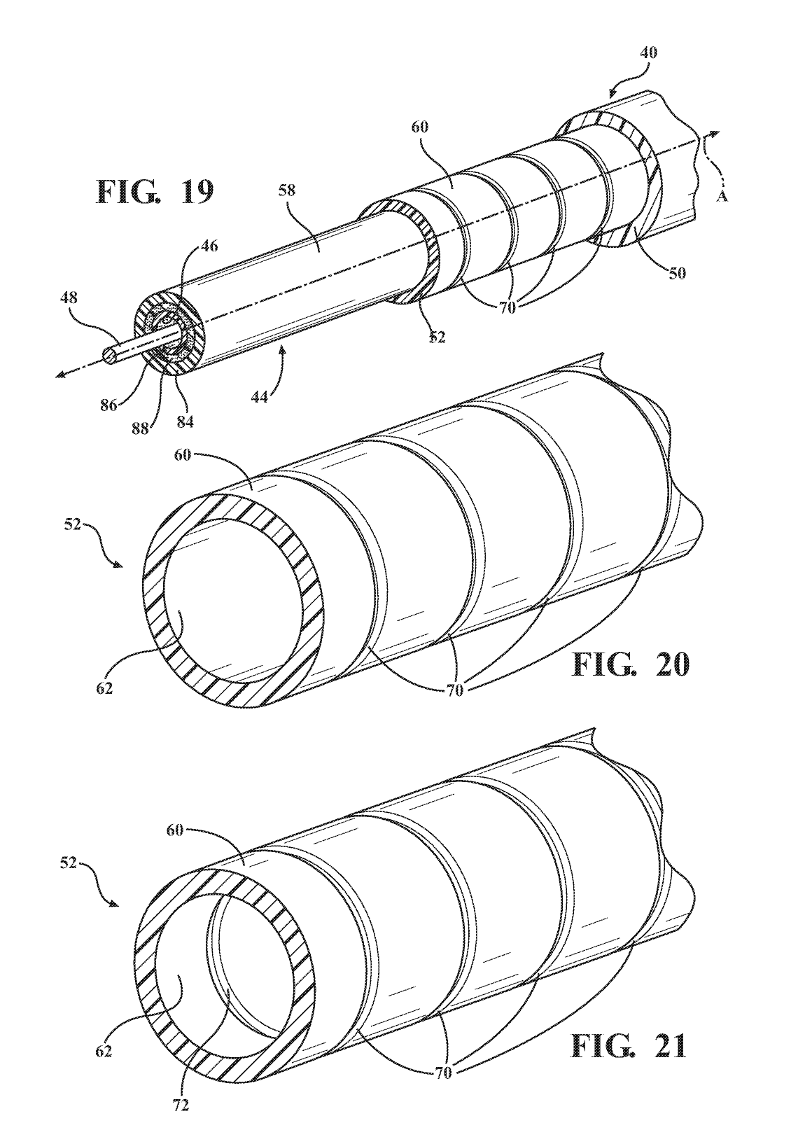

As shown in FIGS. 19-24, the outer support surface 60 defines a plurality of outer grooves 70. In this embodiment, each groove 64 of the plurality of outer grooves 70 are disposed about longitudinal axis A and spaced from one another along length L.

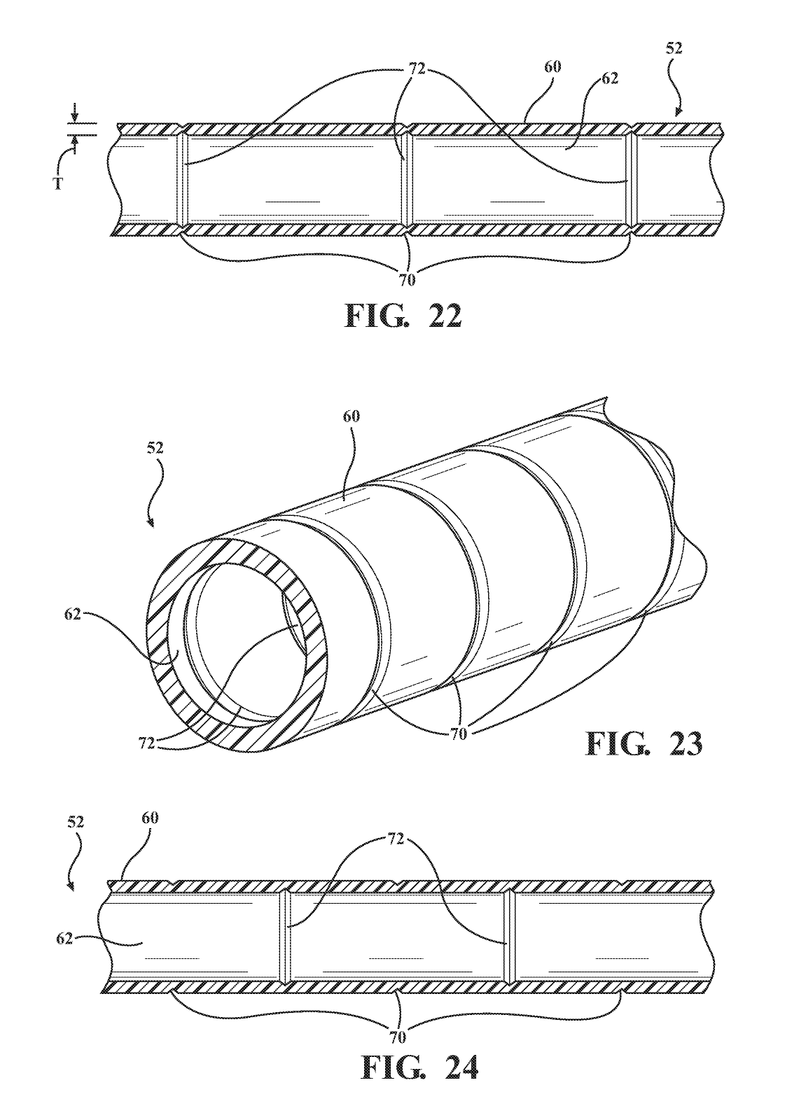

As shown in FIGS. 21-24, the inner support surface defines a plurality of inner grooves 72. Each groove 64 of the plurality of inner grooves 72 are disposed about longitudinal axis A and spaced from one another along length L. Each groove 64 of the plurality of outer grooves 70 may be aligned with one of the grooves 64 of the plurality of inner grooves 72, as shown in FIGS. 21 and 22. Alternatively, each groove 64 of the plurality of outer grooves 70 may be offset from each groove 64 of the plurality of inner grooves, as shown in FIGS. 23 and 24. Depending on the desired flexibility and stiffness desired for the support layer 52, the number and alignment of grooves 64 and plurality of inner grooves 72 and plurality of outer grooves 70 may be adjusted.

When present, the groove 64, as shown in FIGS. 2-24, defines a groove depth GD from the outer support surface 60 toward the inner support surface 62, as best shown in FIGS. 16 and 18. In one embodiment, the groove depth GD is from about 60 to 75 percent of thickness T. In this embodiment, the groove depth GD may be about 66 percent of thickness T. It is to be appreciated that the groove depth GD may be less than 60 percent of thickness T or greater than 75 percent of thickness T without departing form the nature of the present invention. For example, if greater flexibility of the support layer 52 is desired, the groove depth GD may be greater than 75 percent of thickness T, and if greater stiffness is desired, the groove depth GD may be less than 60 percent of thickness T. In other words, the groove depth GD may be adjusted depending on the flexibility and stiffness desired for the support layer 52.

The groove 64 defines a bottom groove surface 74 having a radius R. In one embodiment, radius R is from about 10 to 17 percent of thickness T. In this embodiment, the groove depth GD may be about 13 percent of thickness T. It is to be appreciated that the radius R of groove 64 may have a radius R less than 10 percent of thickness T or greater than 17 of thickness T without departing from the nature of the present. The radius R helps with flexibility of the support layer 52 by minimizing stress concentration within the groove 64.

With reference to FIGS. 16 and 18, when the groove 64 is present, the support layer 52 may present a first groove surface 76 extending from the outer support surface 60 toward the inner support surface 62, and a second groove surface 78 extending from the outer support surface 60 toward the inner support surface 62. The second groove surface 78 faces the first groove surface 76. The first groove surface 76 and the outer support surface 60 intersect at a first edge 80 and the second groove surface 78 and the outer support surface 60 intersect at a second edge 82. The second edge 82 is spaced from the first edge 80 along longitudinal axis A, with the first edge 80 and the second edge 82 defining an edge width EW therebetweeen, and with said edge width EW being from about 20 to 35 percent of thickness T. In one embodiment, the edge width EW is about 27 percent of thickness T. It is to be appreciated that the edge width EW may be greater than 35 percent of thickness T or less than 20 percent of thickness T without departing from the nature of the present invention. For example, if greater flexibility of the support layer 52 is desired, the edge width EW may be greater than 35 percent of thickness T, and if greater stiffness of the support layer is desired, the edge width EW may be less than 20 percent of thickness T.

In one embodiment, the first groove surface 76 and the second groove surface 78 are continuously spaced from one another about longitudinal axis A and along length L. In other words, the first groove surface 76 and the second groove surface 78 do not have a bottom groove surface 74 defining a radius. Said differently, the first groove surface 76 extends from the outer support surface 60 to the inner support surface 62, and the second groove surface 78 extends from the outer support surface 60 to the inner support surface 62. In this embodiment, the first groove surface 76 and the second groove surface 78 are engageable with one another, but the first groove surface 76 and the second groove surface 78 are not integrally formed with one another.

It is to be appreciated that various embodiments of the support layer 52 described above may be adjusted to meet requirements of the support layer 52. For example, depending on whether the support layer 52 defines the groove 64 may depend on use and desired flexibility, stiffness, impact resistance, thermal resistance, chemical resistance, tensile and compression strength, and many other physical and mechanical properties. Additionally, when present, different characteristics, such as the groove depth GD, the edge width EW, and the radius R, of the groove 64 may be adjusted depending on use and desired flexibility, stiffness, impact resistance, thermal resistance, chemical resistance, tensile and compression strength, and many other physical and mechanical properties. Similarly, depending on the resin material of the support layer 52, the groove depth GD, the edge width EW, and the radius R of the groove 64 may be adjusted to obtain the desired flexibility, stiffness, impact resistance, thermal resistance, chemical resistance, tensile and compression strength, and other physical and mechanical properties of the support layer 52. It is to be appreciated that the description above of the GD, bottom groove surface 74, radius R, first groove surface 78, second groove surface 80, first edge 80, second edge 82, and edge width EW applies to the groove 64, outer groove 68, inner groove 66, the plurality of outer grooves 70, and the plurality of inner grooves 72.

In one embodiment, the liner 44 is a single layer, as shown in FIGS. 9 and 27. In another embodiment, as shown in FIGS. 8 and 26, the liner 44 may have two layers further defined as an outer layer 84 and an inner layer 86. In this embodiment, the support layer 52 is mounted to the outer layer 84 and the inner layer 86 is coupled to the outer layer 84.

In another embodiment, as shown in FIGS. 2-7, 19, and 25, the liner 44 may have three layers. In this embodiment, the liner 44 includes an intermediate layer 88 disposed between and mounted to the outer layer 84 and the inner layer 86. In this embodiment, the outer layer 84 may be comprised of a first material, the inner layer 86 may be comprised of a second material different from the first material, and the intermediate layer 88 comprised of a third material different from the first and second materials.

The first material of the outer layer 84 may comprise one or more organic polymers. Although the first material comprises one or more organic polymers, in one embodiment the first material comprises nylon. When the first material comprises nylon, various forms of nylon can be used. For example, the nylon may be a polyamide nylon, nylon 6-6, or combinations thereof. In certain embodiments, the first material comprises nylon and one or more organic polymers. In other embodiments, the first material consists of nylon (i.e., no other organic polymers are present in the first material). When the first material consists of nylon, the first material may consist of polyamide nylon. Of course, when the first material consists of polyamide nylon, the first material may consist of nylon 6-6. Although not required, it is to be appreciated that the first material of the outer layer 84 of the liner 44 may comprise of any other suitable material in addition to nylon, such as, but not limited to, polyphenylsulfone (PPSU), polybutylene terephthalate (PBT), or polypropylene (PP), without departing from the nature of the present invention. In certain embodiments, the organic polymer of the first material may be selected from the group of nylon, polyamide nylon, nylon 6-6, polyphenylsulfone (PPSU), polybutylene terephthalate (PBT), polypropylene (PP), or combinations thereof.

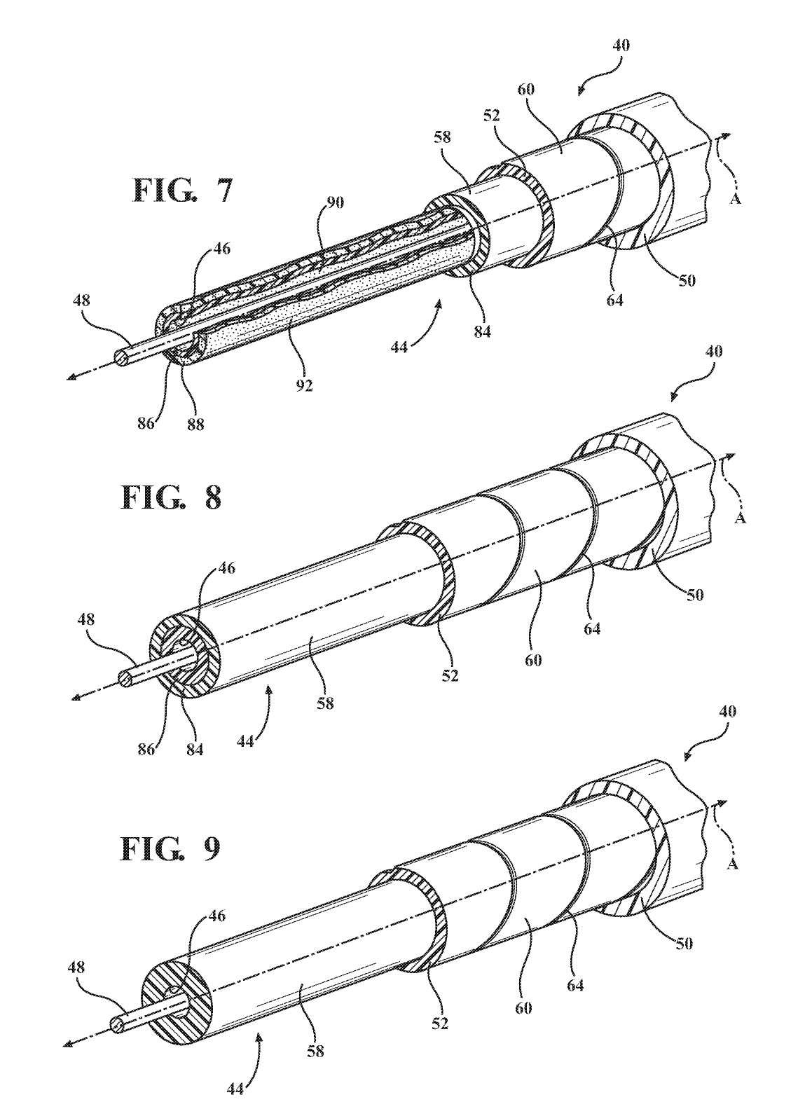

The inner layer 86 of the liner 44 may define a plurality of inner pores 90, as best shown in FIG. 7. The third material of the inner layer 86 may comprise one or more organic polymers. The one or more organic polymers may include any organic polymer suitable for forming the inner layer 86. As non-limiting examples, the one or more organic polymers may include polybutylene terephthalate (PBT), polyethylene (PE), or a combination thereof. It is to be appreciated that when the organic polymer includes polyethylene (PE), various forms of polyethylene (PE) may be used, such as high-density polyethylene (HDPE). In certain embodiments, the third material comprises more than one organic polymer. In other embodiments, the first material consists of a single organic polymer (i.e., only one organic polymer is present in the first material). When the first material consists of a single organic polymer, the first material may consist of polybutylene terephthalate (PBT). Alternatively, when the first material consists of a single organic polymer, the first material may consist of polyethylene (PE). Of course, when the first material consists of polyethylene (PE), the first material may consist of high-density polyethylene (HDPE).

In other embodiments of the third material, the one or more organic polymers include one or more fluoropolymers. Although various fluoropolymers may be used, generally the one or more fluoropolymers includes polytetrafluoroethylene (PTFE). In certain embodiments, the third material comprises a fluoropolymer and one or more organic non-fluorinated polymers. In other embodiments, the third material consists of a single fluoropolymer (i.e., no other polymers are present in the third material). Of course, in this embodiment the third material may consist of polytetrafluoroethylene (PTFE). In yet other embodiments, the one or more organic polymers is selected from the group of polytetrafluoroethylene (PTFE), polybutylene terephthalate (PBT), polyethylene (PE), or combinations thereof.

The inner layer 86 typically has a lubricant disposed within the plurality of inner pores 90. When present, the lubricant migrates within the plurality of inner pores 90 toward the core element 48, which helps lubricate the core element 48 to reduce noise and friction from the core element 48 contacting the inner layer 86. In one embodiment, the lubricant comprises a silicone-based oil. However, it is to be appreciated that the lubricant may be any other lubricant without departing from the nature of the present invention.

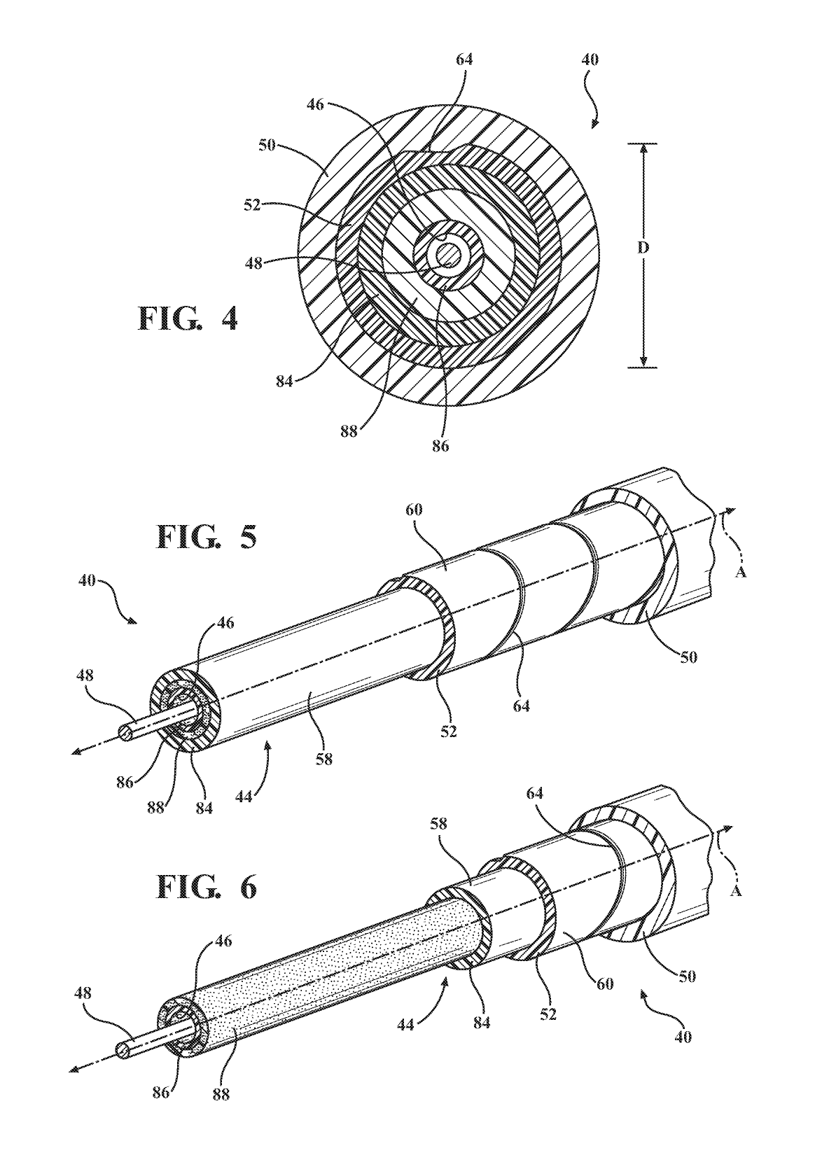

The second material of the intermediate layer 88 may comprise an elastomeric material with the elastomeric material defining a plurality of intermediate pores 92, as best shown in FIG. 7. The elastomeric material of the intermediate layer 88 acts as a dampener between the outer layer 84 and the inner layer 86. The dampening characteristics of the intermediate layer 88 help reduce the vibrations transmitted through the liner 44 and, in turn, the conduit 54. Furthermore, the intermediate layer 88 has the lubricant described above disposed within the plurality of intermediate pores 92. The lubricant migrates from the plurality of intermediate pores 92 to the plurality of inner pores 90 for lubricating the core element 48, as described above. It is to be appreciated that the lubricant may only be disposed within the plurality of inner pores 90 without departing from the nature of the present invention. It is to be further appreciated that if the lubricant is initially only disposed within plurality of intermediate pores 92, the lubricant will migrate into the plurality of inner pores 90 such that the lubricant will lubricate the core element 48. When the lubricant is disposed within the plurality of inner pores 90, or disposed within the plurality of inner pores 90 and the plurality of intermediate pores 92, the need to apply lubricant to the core element 48 prior to manufacturing the cable 40 is eliminated. In other words, the lubricant disposed within the plurality of inner pores 90, or the plurality of inner pores 90 and the plurality of intermediate pores 92, is sufficient for lubricating the core element 48 during operation of the remote control assembly 42 without applying lubricant to the core element 48 prior to manufacturing the cable 40. It is to be appreciated that the intermediate layer 88 and the inner layer 86 may be free of the plurality of intermediate pores 92 and the plurality of inner pores 90, respectively, as shown in FIG. 4, without departing from the nature of the present invention.

It is to be appreciated that configurations of the liner 44 and the sheath 50 throughout the Figures are merely illustrative, and that various components of the liner 44 and the sheath 50 may not be drawn to scale. For example, the liner 44 may have a thickness that is greater or less than the thickness shown throughout the Figures. Furthermore, when the liner 44 is a single layer, as shown in FIGS. 9 and 27, the liner 44 may have a thickness that is greater or less than the thickness shown in FIGS. 9 and 27. Additionally, when the liner 44 comprises two layers, as shown in FIGS. 8 and 26, the outer layer 84 and the inner layer 86 may have a thickness that is greater or less than the thickness of each shown in FIGS. 8 and 26. Also, when the liner comprises three layers, as shown in FIGS. 2-7, 19, and 25, the outer layer 84, the intermediate layer 88, and the inner layer 86 may each have a thickness that is greater or less than the thickness shown in FIGS. 2-7, 19, and 25. Similarly, the sheath 50 may have a thickness that is greater or less than the thickness as shown throughout the Figures. Likewise, diameter D of the support layer 52 or a thickness of the support layer 52 shown throughout the Figures is merely illustrative and may not be drawn to scale.

It is also to be appreciated that various embodiments of the support layer 52 and the liner 44 may be combined with other embodiments of the support layer 52 and the liner 44 without departing from the nature of the present invention. For example, although not explicitly shown in the Figures, the support layer 52 shown in FIGS. 2-24 and FIGS. 25-27 may be combined with embodiments of the liner 44 shown in FIGS. 4-7, 19, and 25.

The invention has been described in an illustrative manner, and it is to be understood that the terminology that has been used is intended to be in the nature of words of description rather than of limitation. Many modifications and variations of the present invention are possible in light of the above teachings, and the invention may be practiced otherwise than as specifically described.

What is claimed is:

1. A cable for use in a remote control assembly, said cable comprising:
a liner having a longitudinal axis along a length thereof and defining an interior;
a core element disposed and moveable within said interior and extending along said length;
a sheath disposed about said liner along said length; and
a support layer mounted to and disposed between said liner and said sheath, with said support layer supporting said liner along said length, reinforcing said sheath along said length, reducing movement of said sheath with respect to said liner and vibrations caused during movement of said core element, and minimizing bending of said liner and said sheath about said longitudinal axis;
wherein said support layer is comprised of a resin material.

2. The cable as set forth in claim 1 wherein said liner presents an outer liner surface facing said support layer, and wherein said support layer presents an outer support surface engaged with said sheath along said length and an inner support surface engaged with said outer liner surface along said length, with said support layer encapsulating said liner.

3. The cable as set forth in claim 2 wherein said inner support surface of said support layer is entirely engaged with said outer liner surface along said length.

4. The cable as set forth in claim 1 wherein said liner, said sheath, and said support layer collectively form a conduit, and with said conduit being free of support wires comprised of metal.

5. The cable as set forth in claim 2 wherein said outer support surface of said support layer defines at least one groove for increasing flexibility of said support layer.

6. The cable as set forth in claim 1 wherein said resin material is a neat polyphenylene sulfide (PPS).

7. The cable as set forth in claim 6 wherein said neat PPS is 15 percent glass filled.

8. The cable as set forth in claim 1 wherein said resin material is a polyphenylsulfone (PPSF)

9. The cable as set forth in claim 1 wherein said resin material is a polyphthalamide (PPA).

10. The cable as set forth in claim 5 wherein said groove is helically disposed about said longitudinal axis and along said length for increasing flexibility of said support layer.

11. The cable as set forth in claim 10 wherein said groove is continuously disposed about said longitudinal axis along said length.

12. The cable as set forth in claim 11 wherein said groove is disposed about said longitudinal axis at a predetermined pitch length as measured relative to said longitudinal axis, with said support layer defining a diameter, and with said pitch length being from about 6 to 7.25 times said diameter.

13. The cable as set forth in claim 12 wherein said pitch length about 6.6 times said diameter.

14. The cable as set forth in claim 5 wherein said support layer defines a thickness from said outer support surface to said inner support surface, and said groove defines a groove depth from said outer support surface toward said inner support surface, with said groove depth being from about 60 to 75 percent of said thickness.

15. The cable as set forth in claim 14 wherein said groove depth is about 66 percent of said thickness.

16. The cable as set forth in claim 5 wherein said support surface defines a thickness from said outer support surface to said inner support surface, with said groove defining a bottom groove surface having a radius being from about 10 to 17 percent of said thickness.

17. The cable as set forth in claim 16 wherein said radius is about 13 percent of said thickness.

18. The cable as set forth in claim 5 wherein said support surface defines a thickness from said outer support surface to said inner support surface, with said support layer presenting a first groove surface extending from said outer support surface toward said inner support surface and presenting a second groove surface extending from said outer support surface toward said inner support surface facing said first groove surface, with said first groove surface and said outer support surface intersecting at a first edge and said second groove surface and said outer support surface intersecting at a second edge spaced from said first edge along said longitudinal axis, with said first edge and said second edge defining an edge width therebetweeen, and with said edge width being from about 20 to 35 percent of said thickness.

19. The cable as set forth in claim 13 wherein said edge width is 27 percent of said thickness.

20. The cable as set forth in claim 4 wherein a portion of said sheath is disposed within said groove.

21. The cable as set forth in claim 1 wherein said sheath is the outermost layer of said cable, with said sheath encapsulating said support layer and said liner, such that said sheath is exposed to the atmosphere.

22. The cable as set forth in claim 1 wherein said liner is further defined as an outer layer and an inner layer, with said support layer mounted to said outer layer and said inner layer coupled to said outer layer.

23. The cable as set forth in claim 22 wherein said liner further comprises an intermediate layer disposed between and mounted to said outer layer and said inner layer with said outer layer comprised of a first material, said inner layer comprised of a second material different from said first material, and said intermediate layer comprised of a third material different from said first and second materials.
